(19) United States
(12) Patent Application Publication
(10) Pub. No.: US 2020/0286298 A1
(43) Pub. Date: Sep. 10, 2020

(54) SYSTEMS AND METHODS FOR A USER INTERACTION PROXY

(71) Applicant: Immersion Corporation, San Jose, CA (US)

(72) Inventors: Vahid Khoshkava, Laval (CA); Jamal Saboune, Montreal (CA); Juan Manuel Cruz-Hernandez, Westmount (CA); Liwen Wu, Montreal (CA); Razmik Mousakhanian, Kirkland (CA)

(73) Assignee: Immersion Corporation, San Jose, CA (US)

(21) Appl. No.: 16/294,237

(22) Filed: Mar. 6, 2019

(51) Int. Cl. G06T 19/20; G06F 3/01

(52) U.S. Cl. CPC G06T 19/20; G06F 3/017; G06F 3/016

(57) ABSTRACT

Systems and methods for an Interaction Proxy are disclosed. One disclosed device includes a structure capable of defining at least a first shape at a first location and a second shape at a second location, the second shape configured to act as an interaction proxy; an actuator coupled to the structure and in communication with a processor, the actuator configured to receive a transition signal from the processor and, in response, transition the structure from the first shape to the second shape. The device also includes a sensor configured to sense an interaction with the structure and generate a sensor signal associated with the interaction and to transmit the sensor signal to the processor.

### FIELD OF THE INVENTION

The present invention generally relates to user interface devices and more particularly to systems and methods for a user interaction proxy.

### BACKGROUND

Haptic-enabled devices and environments have become increasingly popular. Such devices and environments provide a more immersive user experience. Achieving these improvements requires user interfaces that provide realistic haptic effects and interface simulations along with analogous visual simulations on the device or within the environment, such as within a virtual or augmented reality environment. Such interface simulations may be static or lack features associated with a real-world interface. Accordingly, a need exists for improved interfaces.

### SUMMARY

Embodiments provide an improved user interface, including a user interaction proxy. In one embodiment, a device of the present disclosure may comprise a structure capable of defining at least a first shape at a first location and a second shape at a second location, the second shape configured to act as an interaction proxy; and an actuator coupled to the structure and in communication with a processor, the actuator configured to receive a transition signal from the processor and, in response, transition the structure from the first shape to the second shape. The device may further comprise a sensor configured to sense an interaction with the structure and generate a sensor signal associated with the interaction and to transmit the sensor signal to the processor.

In another embodiment, a method comprises receiving a transition signal from a processor corresponding to a virtual object in a virtual or augmented reality environment; and in response to receiving the transition signal, causing a structure defining a first shape at a first location to transition to a second shape at a second location, the second shape configured to act as an interaction proxy. The method further comprises generating a sensor signal associated with an interaction with the structure; and transmitting the sensor signal to a processor.

In yet another embodiment, a non-transitory computer readable medium may comprise program code, which when executed by a processor is configured to cause the processor to execute the method.

### BRIEF DESCRIPTION OF THE DRAWINGS

A full and enabling disclosure is set forth more particularly in the remainder of the specification. The specification makes reference to the following appended figures.

FIG. 1 shows an illustrative system for an Interaction Proxy according to one embodiment.

FIG. 2 shows an illustrative Interaction Proxy according to one embodiment.

FIG. 3 shows another illustrative Interaction Proxy according to one embodiment.

FIG. 4 shows yet another illustrative Interaction Proxy according to one embodiment.

FIG. 5 is a flow chart for operation of an Interaction Proxy according to one embodiment.

### DETAILED DESCRIPTION

Reference will now be made in detail to various and alternative illustrative embodiments and to the accompanying drawings. Each example is provided by way of explanation, and not as a limitation. It will be apparent to those skilled in the art that modifications and variations can be made. For instance, features illustrated or described as part of one embodiment may be used in another embodiment to yield a still further embodiment. Thus, it is intended that this disclosure include modifications and variations as come within the scope of the appended claims and their equivalents.

### Illustrative Example of an Interaction Proxy

The present invention provides an interaction proxy that can adapt its shape and/or location based on the intended use by a user. Such proxies may be used for any interactions with a computing platform in place of a mouse or gamepad and may be particularly useful in a virtual or augmented reality (“VR/AR”) environment. Such proxies may be used individually or in combination with additional proxies, depending on the particular embodiment. As the user interacts with virtual objects in the VR/AR environment, the system can cause a structure to change shape or location or both.

For example, a user may interact with a physical sphere, which represents a ball displayed in the VR/AR environment. The user turns her head and sees a knob in the virtual environment and reaches for the knob. The system causes the sphere to change shapes into a knob and move to a location at which the object is located in relation to the user in the virtual environment. For example, if the sphere is directly in front of the user in the virtual environment but the knob is on the user's right side, the system changes the shape of the sphere to a knob and moves the structure to the user's right side. Because the user is experiencing a VR/AR environment, the shape need not be exact; the user's other senses will affect the user's perception of the shape of the interaction proxy.

The structure may change shape in a number of ways. For example, in one illustrative example, the outer shell of the interaction proxy includes a plurality of sections each made from a shape memory material. Each of the sections can be separately manipulated or actuated, e.g., by applying an electric current, to change shapes and cause the overall shape of the interaction proxy to change. In other examples, an internal backbone structure may cause the outer shape to change. In yet other examples, the structure may be created as a foldable shape, similar to an origami structure, that changes shape when a force is applied in various locations. The change in shape may comprise a change to the overall shape, may comprise a change to the surface of the structure, or may comprise some combination of the two.

The illustrative interaction proxy allows the user to provide input by sensing the user's interaction with the proxy. For example, if the user spins the knob, the knob sends a signal to a processor that indicates the direction, speed, and magnitude of the spinning. The processor can then use the signal to affect the virtual object in the VR/AR environment.

The illustrative interaction proxy may also allow the user to experience haptic feedback. For instance, the knob may provide resistance or may click as it's rotated as a mechanical knob would. In some embodiments, the interaction proxy might vibrate or provide a sense of texture to the user. In other embodiments, the interaction proxy may provide temperature-based haptic effects, either heating or cooling the surface of the interaction proxy. In some embodiments, the user may experience a haptic effect, such as a change is surface friction, that causes the user to believe the surface texture has changed even if it has not.

These illustrative examples are given to introduce the reader to the general subject matter discussed herein and the disclosure is not limited to these examples. The following sections describe various additional non-limiting examples of the present disclosure.

### Illustrative Systems for an Interaction Proxy

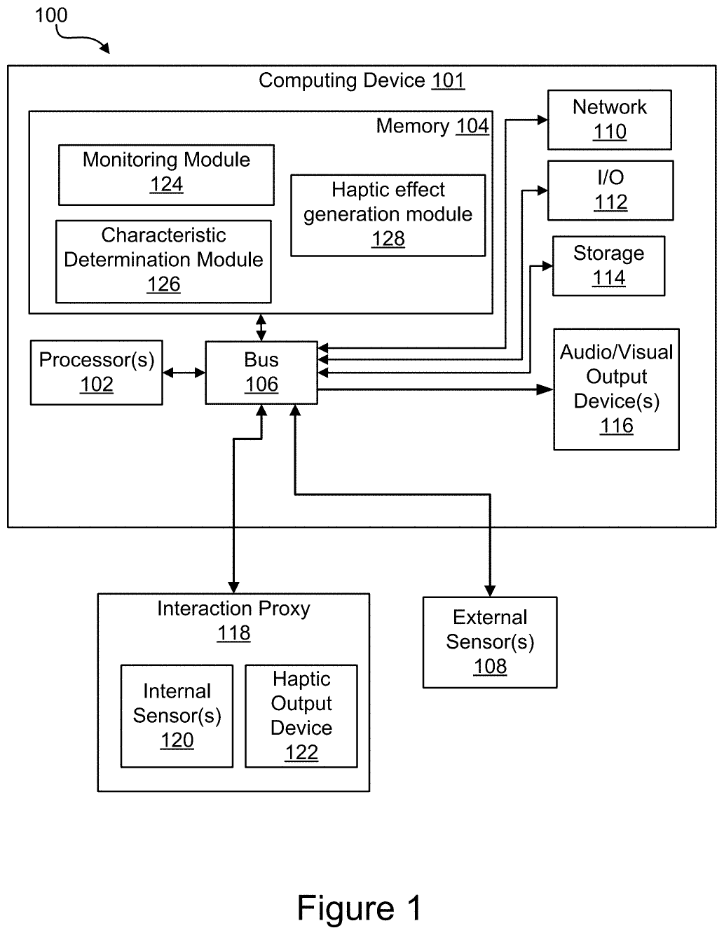

FIG. 1 shows an illustrative system 100 for controlling and communicating with an interaction proxy. Particularly, in this example, system 100 comprises a computing device 101 having a processor 102 interfaced with other hardware via bus 106, and memory 104. Computing device 101 may comprise, for example, a server, cloud-based or local, a laptop, tablet, or mobile phone or other type of computer or computing device.

Memory 104, which can comprise any suitable tangible (and non-transitory) computer-readable medium such as RAM, ROM, EEPROM, or the like, embodies program components that configure operation of the computing device 101. In this example, computing device 101 further includes one or more network devices 110, input/output (I/O) interface components 112, and additional storage 114.

Network device 110 can represent one or more of any components that facilitate a network connection. Examples include, but are not limited to, wireless interfaces such as IEEE 802.11, Bluetooth, or radio interfaces for accessing cellular telephone networks (e.g., transceiver/antenna for accessing a CDMA, GSM, UMTS, or other mobile communications network) and/or wired interfaces such as Ethernet, USB, IEEE 1394.

I/O components 112 may be used to facilitate connection to devices such as one or more displays, headsets comprising displays, curved displays (e.g., the display includes angled surfaces extended onto one or more sides of computing device 101 on which images may be displayed), keyboards, mice, speakers, microphones, cameras (e.g., a front and/or a rear facing camera on a mobile device) and/or other hardware used to input data or output data. In particular, I/O components 112 may be used for communication with the interaction proxy 118 or external sensor(s) 108. Storage 114 represents nonvolatile storage such as magnetic, optical, or other storage media included in computing device 101.

Audio/visual output device(s) 116 comprise one or more devices configured to receive signals from processor(s) 102 and provide audio or visual output to the user. For example, in some embodiments, audio/visual output device(s) 116 may comprise a display such as a touch-screen display, LCD display, plasma display, CRT display, projection display, a headset comprising a display for each eye (e.g., for use in mixed/augmented reality or virtual reality), or some other display known in the art. Further, audio/visual output devices may comprise one or more speakers configured to output audio to a user.

One or more external sensors 108 may be configured to detect an interaction with or detect the location of the interaction proxy 118. For example, such sensors may detect a touch in a touch area when an object contacts a touch surface of the interaction proxy 118 and provide appropriate data for use by processor 102. As another example, such sensors may detect the three-dimensional position of the interaction proxy 118. Any suitable number, type, or arrangement of sensors can be used. As another example, optical sensors with a view of the interaction proxy 118 may be used to determine the touch position. For example, in one embodiment, the sensor may comprise a sensor configured to use electromyography (EMG) signals to detect pressure applied by a user on a surface of the interaction proxy 118. Further, in some embodiments, the sensor may comprise RGB or thermal cameras and use images captured by these cameras to estimate where the user exerting a force on a surface as well as an amount of pressure the user is exerting on the surface. In other embodiments, the sensor 108 may comprise an LED detector. In some embodiments, the processor 102 is in communication with a single sensor 108, in other embodiments, the processor is in communication with a plurality of external sensors 108.

In the example shown in FIG. 1, an interaction proxy 118 is in communication with processor 102 via bus 106. The interaction proxy 118 allows a user to interact with a VR/AR environment. In the embodiment shown, the interaction proxy 118 comprises one or more internal sensors 120 and a haptic output device 122. Although a single interaction proxy 118 is shown in FIG. 1, embodiments may use multiple interaction proxies of the same or different type. For example, in one embodiment, a first interaction proxy 118 may be configured for the user to grasp with a right hand, while a second interaction proxy 118 is configured for the user to grasp with a left hand.

In some embodiments one or more sensor(s) 120 comprise sensors to detect a user's interaction with the interaction proxy, such as a touch or pressure. For example, the sensor 120 could be a button or a capacitive sensor located where a button might be made visible in a VR/AR environment. In other embodiments the sensor(s) 120 may further comprise one or more sensors configured to detect movement of the interaction proxy 118 (e.g., accelerometers, gyroscopes, cameras, GPS, or other sensors). The sensor(s) 120 may be configured to detect user interaction that moves the device in the X, Y, or Z plane as well as the change in location. The sensor 108 is configured to detect user interaction and/or location, and based on the user interaction and/or location, transmit signals to processor 102.

In some embodiments, sensor 108 may be configured to detect multiple aspects of the user interaction. For example, sensor 108 may detect the speed and pressure of a user interaction and incorporate this information into the interface signal. Further, in some embodiments, the user interaction comprises a multi-dimensional user interaction away from the device. For example, in some embodiments a camera associated with the device may be configured to detect user movements, e.g., hand, finger, body, head, eye, or feet motions or interactions with another person or object. In some embodiments, the sensor(s) 108 may be internal to the device 101, external to the device 101, or some combination of internal and external sensors, including external sensor(s) 108.

For example, resistive and/or capacitive sensors may be embedded in one or more surfaces of interaction proxy 118 and used to determine the location of a touch and other information, such as pressure.

In some embodiments, interaction proxy 118 is configured, in response to a haptic signal, to output a haptic effect. For example, interaction proxy 118 may provide vibrotactile haptic effects. Some haptic effects may utilize an actuator coupled to the internal structure of the interaction proxy 118. And some haptic effects may use multiple haptic output devices in sequence and/or in concert. For example, in some embodiments, a surface texture may be simulated by vibrating the surface of the interaction proxy 118 at different frequencies.

In such an embodiment, interaction proxy 118 may comprise one or more of, for example, a linear resonant actuator (LRA), a piezoelectric actuator, an eccentric rotating mass motor (ERM), an electric motor, an electro-magnetic actuator, a voice coil, a shape memory alloy, an electro-active polymer, or a solenoid. In some embodiments, the haptic output device may comprise a Peltier cell to cause the user to experience a thermal effect. In some embodiments, interaction proxy 118 may comprise a plurality of haptic output devices, for example an ERM and an LRA.

In some embodiments, the haptic effect may be modulated based on a variety of factors, including physical characteristics of the interaction proxy 118, an object with which the user interacts either virtually or in the real-world or some combination of the two (e.g., AR), or on information captured regarding a user interaction. Such interaction information may include, for example, relative position of a user's hands in a virtual environment, an object's position in a VR/AR environment, an object's deformation, a relative object interaction in a GUI, UI, AR, VR, etc. In still other embodiments, methods to create the haptic effects include the variation of an effect of short duration where the magnitude of the effect varies as a function of a sensed signal value (e.g., a signal value associated with user interaction). In some embodiments, when the frequency of the effect can be varied, a fixed perceived magnitude can be selected and the frequency of the effect can be varied as a function of the sensed signal value. In other embodiments, the shape of the signal for producing the haptic effect may be varied based on information, such as the user's interaction or physical characteristics of an object.

Interaction proxy may also comprise one or more of sensors 120. Sensors 120 may be coupled to processor 102 and used to monitor positions of the interaction proxy 118 or a mass moved by the interaction proxy 118 to output a haptic effect. Alternatively, sensors 120 may be used to track the movement of a user or users or of objects. Such sensors 120 may be in communication with the device but physically separate. In some embodiments, sensors 120 may comprise optical sensors, magnetic field sensors, audio based sensors, or sensors configured to detect a Doppler shift. In some embodiments two sensors 120 may detect the position of the interaction proxy 118 or a mass moved by the interaction proxy 118.

Turning to memory 104, exemplary program components 124, 126, and 128 are depicted to illustrate how a device may be configured to monitor the interaction proxy 118, make determinations about its shape, and calculate or determine and then output haptic effects. In this example, a monitoring module 124 configures processor 102 to the interaction proxy 118 via sensor 108 and/or sensor 120 and also a VR/AR environment to determine whether a change in shape and/or location should be made. For example, module 124 may receive a signal from the VR/AR environment and determine the current shape of the interaction proxy 118. The module 124 may also sample sensors 108, 120 in order to track the presence or absence of a touch and, if a touch is present, to track one or more of the location, path, velocity, acceleration, pressure, and/or other characteristics of the touch or the interaction proxy 118 over time.

Characteristic determination module 126 represents a program component that analyzes data regarding characteristics, such as physical characteristics of an object or objects and environments in which the objects interact, user interaction characteristics (e.g., touch characteristics), and other characteristics to determine the appropriate shape and/or location of the interaction proxy or the appropriate characteristics of any haptic effects to be output.

Haptic effect generation module 128 represents programming that causes processor 102 to generate and transmit a haptic signal to haptic output device 122, which causes haptic output device 122 to generate the selected haptic effect. For example, generation module 128 may access stored waveforms or commands to send to haptic output device 122. As another example, haptic effect generation module 128 may receive a desired type of haptic effect and utilize signal processing algorithms to generate an appropriate signal to send to haptic output device 122. As a further example, a desired haptic effect may be indicated along with target coordinates for the desired haptic effect and an appropriate waveform sent to one or more haptic output devices to generate appropriate displacement of the surface (and/or other device components) of the interaction proxy 118 to provide the haptic effect. Some embodiments may utilize multiple haptic output devices in concert to simulate a feature. For instance, a variation in texture may be used to simulate various characteristics of objects or events while a vibrotactile effect simulates the response for other objects or events.

System 100 may further implement closed-loop control of haptic effects. For example, in one embodiment, processor 102 may output a haptic signal corresponding to a desired haptic effect to the haptic output device 122. The processor 102 may also receive a reference signal. The reference signal may represent a sensor signal that would be generated if a haptic output device accurately created a haptic effect. At the same time the processor 102 may receive a sensor signal from internal sensor 120 corresponding to the haptic effect that is currently output. The processor 102 may determine an error between the reference signal and the signal received from internal sensor 120. Based on the error, the processor 102 can determine how to modify the haptic signal to achieve an effect that is more representative of the reference signal. For instance, the processor 102 may increase the gain or other parameters of the haptic signal to create a stronger effect. Alternatively, the processor 102 might utilize a different type of controller, such as a proportional or proportional integral controller to modify the haptic signal. Further the processor 102 may implement a combination of varying the gain and type of controller used to modify the haptic signal.

Illustrative Embodiments of an Interaction Proxy

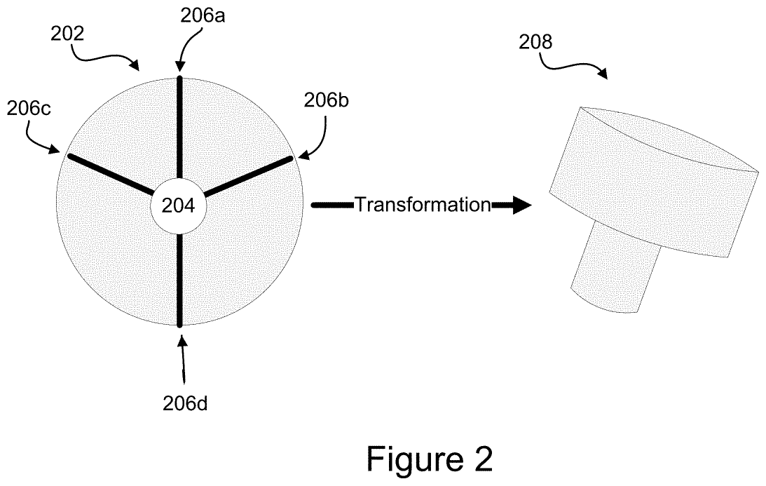

FIG. 2 shows an illustrative embodiment of an Interaction Proxy. In the embodiment shown, a sphere 202 has a shell made form a soft material. The sphere 202 may contain sensors to sense a user interaction with the sphere 202. The sphere 202 may also include a haptic output device for providing haptic effects to a user grasping the sphere 202.

Inside the sphere is a central point 204 to which a set of arms 206 that form an internal backbone structure is connected. Each arm 206 comprises a material that can expand or compress. For instance, an arm may comprise a piezo-electric material. In another embodiment, the arm may be telescopic and may expand or compress via hydraulic, pneumatic, electromagnetic, or other mechanical means. In another embodiment, the central point 204 may comprise a motor configured to manipulate the arms. In yet another embodiment, the arms may be designed like the structure of an umbrella and use a solenoid or other linear actuator to extend the arms and change the shape of the sphere 202.

Each arm 206 is configured to modify the shape of the sphere 202 in some manner so that it can transform to another shape. For example, as an arm 206 expands or compresses, it pushes or pulls the exterior surface of the sphere 202. In the embodiment shown in FIG. 2, as the arms 206 compress or expand from their original lengths, they cause the sphere 202 to transform into a knob.

In some embodiments, the arms 206 might also be manipulated to change the location of the sphere 202. For example, moving one arm 206b might cause the sphere 202 to shift locations in that direction. In other embodiments, a mass might be moved within the sphere 202 to cause it to roll or otherwise shift locations. A magnet, external to the sphere, might also be used to affect the mass and cause the sphere 202 to move.

In another embodiment, the transformation from sphere 202 to knob 208 occurs without the need for arms 206. In one such embodiment, the sphere 202 is hollow and comprises small sections, each of which is formed from a shape memory material. The shape memory material may be a polymer, metal, or some combination of both. Each section is configured to change shapes such that when they all change shapes, the sphere 202 transforms into the knob 208 as illustrated in FIG. 2. Thus, the sections individually or collectively act as an actuator to cause the transition to occur. The change in shape may be accomplished by, for example, applying heat or light to the material. For example, in one embodiment, ultrasound is directed at the shape to generate heat and cause the sphere 202 to transition.

The one-to-one shape transformation shown in FIG. 2 is merely illustrative. In other embodiments, shape-memory materials or mechanical means or some combination of the two may be used to transform a first shape into more than one second shape and back. For example, depending on the sectioning of the sphere, the sphere might transform into a disk or a knob, depending on how the shape memory materials are manipulated.

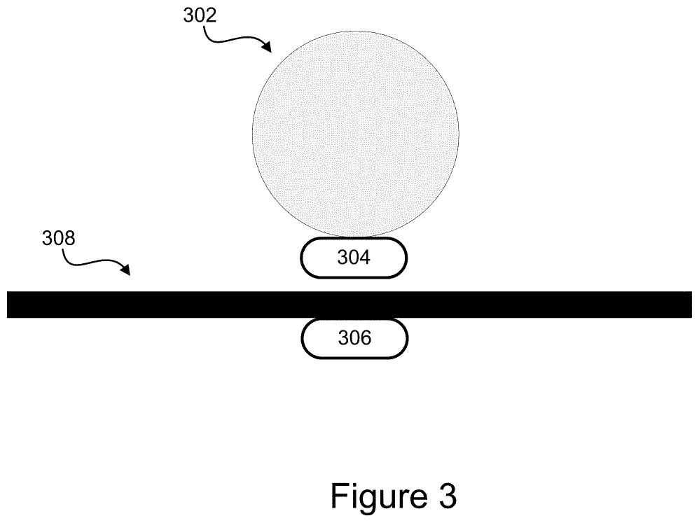

FIG. 3 is another embodiment of an interaction proxy. In the embodiment shown in FIG. 2, a sphere 302 is affixed to a magnet 304. In the embodiment shown, the magnet 304 is attached to the bottom of the sphere 302. However, this is merely illustrative. Other shapes may be utilized for the interaction proxy, and the magnet may be inside or outside the object.

The embodiment shown also comprises a second magnet 306 located beneath a surface 308. The surface 308 may comprise, for example, a table. The magnets 304, 306 are configured such that they stay within a defined distance of one another. For instance, if the magnet 306 is located directly beneath the surface 308, then the sphere 302 remains a fixed distance above the surface 308. In embodiments, the magnets 304, 306 may comprise a single magnet or a plurality of magnets working together.

In the embodiment shown, using the magnets 304, 306, the sphere 302 is levitated above the surface 308. As the magnet 306 moves beneath the surface 308, it causes the sphere 302 to move in the same direction and by the same distance above the surface. Thus, the magnets 304, 306 act as an actuator to transition the location of the sphere 302. In some embodiments, other types of actuators may be used to transition the location. For example, a robotic arm might be used to move the sphere 302.

By moving the object (sphere 302), embodiments are able to provide an interaction proxy for the objects displayed in the virtual environment. The virtual object may be linked explicitly to a particular interaction proxy, such as sphere 302. And in some embodiments where multiple interaction proxies are used, each interaction proxy might correspond to one virtual object. In such embodiments, as the virtual object changes, the interaction proxy associated with the virtual object transitions. In other embodiments, the interaction proxy may be associated with multiple virtual objects and so transitions between various shapes depending on which virtual object is currently active from a user's perspective or otherwise.

Embodiments such as those shown in FIG. 3 may be used in a variety of applications. For instance, a virtual reality environment may display an object moving towards a user's hand. As the object approaches the user, the user is able to reach out and grab or otherwise interact with the object. In the embodiment shown in FIG. 3, the sphere 302 can be controlled so as to approach the user in the physical environment in the same or similar manner as the object shown in the virtual reality environment so that when the user reaches out to grasp the object, the user feels a real object. The shape of the object, a sphere 302 in FIG. 3, may or may not accurately represent the object in the virtual reality environment in some embodiments. In some such embodiments, it may not be necessary to accurately represent the shape shown in the virtual reality environment because the visual cues that the user experiences in the virtual environment may cause the user to interpret the shape of the sphere 302 as approximating the virtual object even if their shapes are different.

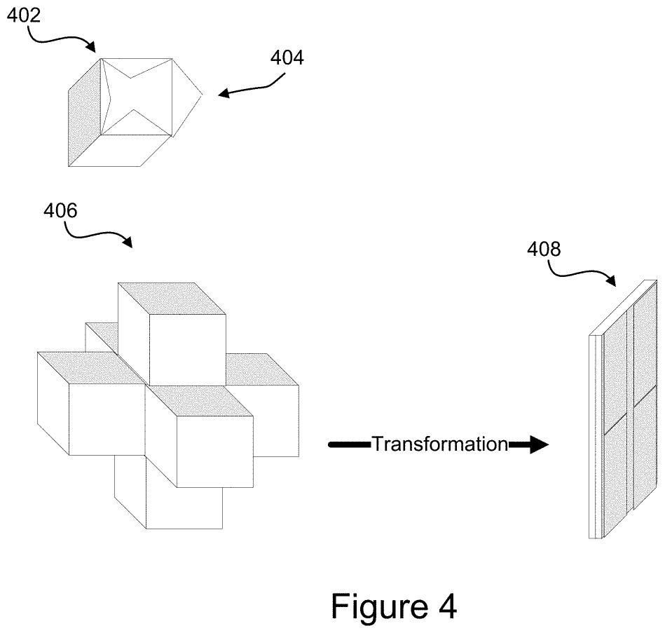

FIG. 4 is another embodiment of an interaction proxy. The embodiment shown in FIG. 4 comprises a plurality of cubes 402. Each cube 402 includes four sides affixed to one another such that the cube can be folded flat. Each cube 402 also includes a series of flaps 404 on one side that allow the cube 402 to be attached to other cubes to form a structure, such as structure 406.

The corners of each cube 402 and the flaps 404 may be constructed from a shape-changing material such that an electrical current causes a compressive force on the structure 404. When the electrical current is applied, the structure transforms into a substantially flat structure 408. For example, magnets could be arrayed around various edges of the cubes 402 to cause a compressive force. In other embodiments, the cubes could include shape-changing materials at the edges to create the force when electricity, light, or heat was applied to the structure. The structure may have additional intermediate shapes between the initial shape 406 and the final shape 408. Such an embodiment might be useful to simulate an object, crushing, flattening, disappearing, or breaking in a virtual or augmented reality environment.

Various other combinations of materials and shapes are possible. For example, the interaction proxy 118 may begin as a cup and transition to a bottle. In another embodiment, the interaction proxy 118 might transition from a pistol to a rifle.

### Illustrative Method for an Interaction Proxy

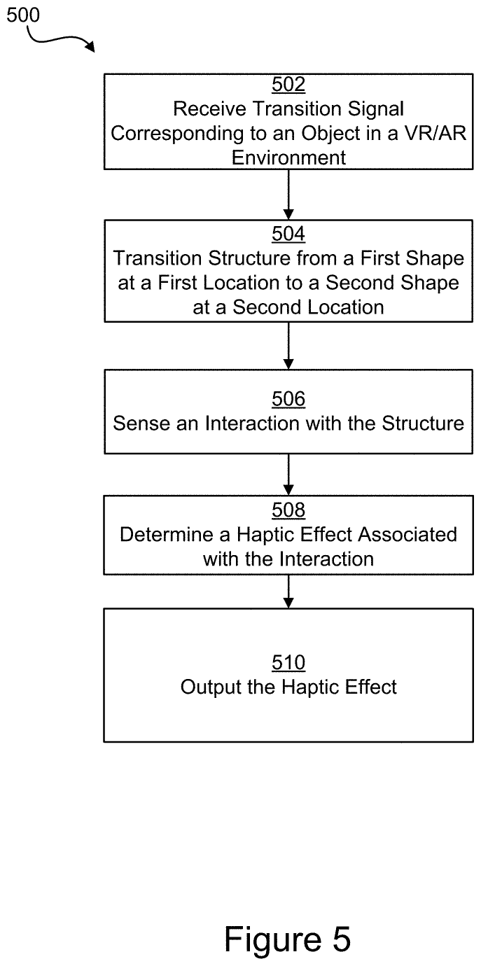

FIG. 5 is a flow chart illustrating a process for an Interaction Proxy according to one embodiment. In some embodiments, the steps may be implemented in program code executed by a processor, for example, the processor in a general purpose computer, mobile device, or server. In some embodiments, these steps may be implemented by a group of processors. In some embodiments the steps may be performed in a different order. Alternatively, in some embodiments, one or more of the steps may be skipped, or additional steps not shown may be performed. The steps below are described with reference to elements described above with regard to computing device 101 shown in FIG. 1.

The method 500 begins at step 502 when processor 102 receives a signal corresponding to an object in a VR/AR environment. For example, the processor 102 may receive a transition signal indicating that, for example, a particular object is in a user's field of vision, that the user is reaching for the object, and various properties of the object. The transition signal may also comprise additional information, such as the distance between the user's avatar and the object in the virtual environment. In other embodiments, the signal simply instructs the processor to cause a transition.

In step 504, the processor 102 determines that the structure of the interaction proxy 118 should change shape and/or location and so causes the structure to transition. For example, the processor 102 may cause the sphere 202 in FIG. 2 to transition to a knob 208. Further, the processor 102 may cause the knob 208 to move from a first location to a second location so that it is where the user's hand is reaching in the VR/AR environment. In some embodiments, the interaction proxy 118 may transition from a first location to a second location but maintain substantially the same shape. In other embodiments, the interaction proxy 118 may transition from one shape to another but maintain substantially the same location.

At step 506, the processor 102 next receives a signal from a sensor 108, 120 indicating an interaction with the structure of the interaction proxy 118. For example, an internal sensor 120 might indicate that a user has grasped knob 208. Alternatively, an external sensor 108 might indicate the interaction proxy's 118 location and that the user's hand is placed in proximity to the knob 208. In another embodiments, the interaction comprises a gesture.

In some embodiments, the user interacts with multiple interaction proxies 118. In such an embodiment, the second interaction proxy 118 may comprise internal sensors 120. The external sensor 108 may be configured to track both interaction proxies 118 or may be configured to track only one, while other sensors track the second interaction proxy 118. Each interaction proxy 118 may be individually identified. For instance, each interaction proxy may comprise a USB human interface device that can be individually polled and tracked by the processor 102. Such interaction proxies 118 may be custom USB HID class devices to allow flexibility in the particular features made available on the interaction proxy 118. Such proxies 118 may require specific drivers executed by the processor 102.

At step 508, the processor determines a haptic effect associated with the interaction. For example, as the user grasps knob 208, the system may determine that a vibrotactile or kinesthetic haptic effect should be output. At step 510 the haptic output device 122 outputs the haptic effect. For example, in one embodiment, the haptic output device 122 may output a texture-based haptic effect. As another example, as the user rotates the knob 208, the haptic output device 122 outputs a click for each portion of a rotation, thereby simulating a physical knob.

### Advantages of an Interaction Proxy

There are numerous advantages of an Interaction Proxy. For example, embodiments disclosed herein may provide a more immersive experience by allowing the system to provide the user with the illusion that the user is interacting with a plurality of different user input devices when in reality, only one or a small number of interaction proxies is made available. By limiting the number of interaction proxies, the system can be made more efficient while maintaining a high level of interest for a user.

### GENERAL CONSIDERATIONS

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process that is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bound the scope of the claims.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

Embodiments in accordance with aspects of the present subject matter can be implemented in digital or analog electronic circuitry, in computer hardware, firmware, software, or in combinations of the preceding. In one embodiment, a computer may comprise a processor or processors. The processor comprises or has access to a computer-readable medium, such as a random access memory (RAM) coupled to the processor. The processor executes computer-executable program instructions stored in memory, such as executing one or more computer programs including a sensor sampling routine, selection routines, and other routines to perform the methods described above.

Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example tangible computer-readable media, that may store instructions that, when executed by the processor, can cause the processor to perform the steps described herein as carried out, or assisted, by a processor. Embodiments of computer-readable media may comprise, but are not limited to, all electronic, optical, magnetic, or other storage devices capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. Also, various other devices may include computer-readable media, such as a router, private or public network, or other transmission device. The processor, and the processing, described may be in one or more structures, and may be dispersed through one or more structures. The processor may comprise code for carrying out one or more of the methods (or parts of methods) described herein.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

What is claimed:

1. A device comprising:
a structure capable of defining at least a first shape at a first location and a second shape at a second location, the second shape configured to act as an interaction proxy;
an actuator coupled to the structure and in communication with a processor, the actuator configured to receive a transition signal from the processor and, in response, transition the structure from the first shape to the second shape; and
a sensor configured to sense an interaction with the structure and generate a sensor signal associated with the interaction and to transmit the sensor signal to the processor.

2. The device of claim 1, wherein the processor is configured to generate the transition signal based at least in part on: a field of view of a user in a virtual environment, a location of a virtual object, a distance between a virtual object and an avatar, or a property of a virtual object.

3. The device of claim 1, further comprising a haptic output device configured to receive a haptic signal from the processor and output a haptic effect to a user of the interaction proxy in response to the haptic signal.

4. The device of claim 3, wherein the processor is configured to determine the haptic signal based at least in part on: the transition signal, the interaction with the structure, the first shape, or the second shape.

5. The device of claim 1, wherein the actuator comprises one or more of: a shape memory material, a backbone internal to the structure, a mass internal to the structure, or an electro-magnetic actuator.

6. The device of claim 1, wherein the second shape corresponds to a virtual shape in a virtual or augmented reality environment.

7. The device of claim 1, wherein the second location corresponds to a virtual location in a virtual or augmented reality environment.

8. The device of claim 1, wherein the first shape is one or more of: a sphere or a foldable geometric shape.

9. The device of claim 1, wherein the first shape and the second shape are substantially the same.

10. The device of claim 1, wherein the first location and the second location are substantially the same.

11. The device of claim 1, wherein the interaction comprises one of: a contact with the structure, a movement in proximity to the structure, or a gesture.

12. A method comprising:
receiving a transition signal from a processor, the transition signal corresponding to a virtual object in a virtual or augmented reality environment;
in response to receiving the transition signal, causing a structure defining a first shape at a first location to transition to a second shape at a second location, the second shape configured to act as an interaction proxy;
generating a sensor signal associated with an interaction with the structure; and
transmitting the sensor signal to the processor.

13. The method of claim 12, wherein the processor is configured to generate the transition signal based at least in part on: a field of view of a user in a virtual environment, a location of a virtual object, a distance between a virtual object and an avatar, or a property of a virtual object.

14. The method of claim 12, further comprising outputting a haptic effect via a haptic output device.

15. The method of claim 14, wherein the processor is configured to determine a haptic signal configured to output the haptic effect based at least in part on: the transition signal, the interaction with the structure, the first shape, or the second shape.

16. The method of claim 12, wherein the structure comprises one or more of: a shape memory material, a backbone internal to the structure, a mass internal to the structure, or an electro-magnetic actuator.

17. The method of claim 12, wherein the first shape is one or more of a sphere or a foldable geometric shape.

18. The method of claim 12, wherein the first shape and the second shape are substantially the same.

19. The method of claim 12, wherein the first location and the second location are substantially the same.

20. The method of claim 12, wherein the interaction comprises one of: a contact with the structure, a movement in proximity to the structure, or a gesture.
